(19) United States
(12) Patent Application Publication
(10) Pub. No.: US 2008/0261060 A1
(43) Pub. Date: Oct. 23, 2008

(54) PROCESS FOR PRODUCING POLYIMIDE FILM, AND POLYIMIDE FILM

(75) Inventor: Hiroaki Yamaguchi, Ube-shi (JP)

Correspondence Address: KNOBBE MARTENS OLSON & BEAR LLP, 2040 MAIN STREET, FOURTEENTH FLOOR, IRVINE, CA, 92614, US

(73) Assignee: UBE INDUSTRIES, LTD, Yamaguchi (JP)

(21) Appl. No.: 12/106,150

(22) Filed: Apr. 18, 2008

(30) Foreign Application Priority Data
Apr. 18, 2007 (JP) 2007-109504

(51) Int. Cl. B32B 15/08; C08G 73/10

(52) U.S. Cl. 428/458; 528/26

(57) ABSTRACT

A solution containing a polyamic acid oligomer having at least one terminal alkoxysilyl group is applied to one side or both sides of a self-supporting film of a polyimide precursor solution, and then the self-supporting film is heated to effect imidization, thereby providing a polyimide film with reliably improved adhesiveness.

### CROSS REFERENCE TO RELATED APPLICATION

This application claims priority to Japanese Application Number 2007-109504, filed on Apr. 18, 2007, which is hereby incorporated by reference in its entirety.

### BACKGROUND OF THE INVENTION

1. Field of the Invention

The present invention relates to a process for producing a polyimide film with improved adhesiveness. The present invention also relates to a polyimide film produced by the above process, and a copper-clad polyimide film.

2. Background Art

A polyimide film is widely used in various applications such as the electric/electronic device field and the semiconductor field, because it has excellent heat resistance, chemical resistance, mechanical strength, electric properties, dimensional stability and so on. For example, a commonly used flexible printed circuit board (FPC) is a copper-clad laminate wherein a copper foil is laminated on one side or both sides of a polyimide film.

However, a polyimide film may not have sufficiently adhesive properties. When a metal foil such as a copper foil is bonded onto a polyimide film with a heat-resistant adhesive such as an epoxy resin adhesive, high adhesive strength may not be achieved. Furthermore, a laminate having high peel strength may not be obtained when a metal layer is formed on a polyimide film by vapor deposition or sputtering.

As a method for improving adhesive property of a polyimide film, Japanese Kokoku Patent Publication No. 1994-002828 (Patent document 1) discloses a process for producing a polyimide film wherein a surface treatment solution containing 0.5 wt % or more of at least one heat-resistant surface treating agent (coupling agent) selected from the group consisting of aminosilane coupling agents and epoxysilane coupling agents, and 20 wt % or less of water is evenly applied to a surface of a self-supporting film (a solidified film) of a polyimide precursor solution; and then the solidified film with the applied surface treatment solution is heated to 100 to 600° C., thereby drying and heat-treating the solidified film, and imidating a polyamic acid contained in the film. In addition, Japanese Laid-open Patent Publication No. 1988-99281 (Patent document 2) discloses a process for producing a polyimide film wherein a polyamic acid varnish is flow-casted and dried to form a polyamic acid film; and the film is dipped into a solution of a silane coupling agent; and then the film is heated to effect ring closure (imidization).

List of References

Patent document 1: Japanese Kokoku Patent Publication No. 1994-002828;

Patent document 2: Japanese Laid-open Patent Publication No. 1988-99281.

### SUMMARY OF THE INVENTION

Conventionally, a self-supporting film of a polyimide precursor solution is prepared by flow-casting and applying a solution of a polyimide precursor on a support such as a stainless substrate and a stainless belt, and then heating it sufficiently to make it self-supporting, which means a stage before a common curing process; specifically, heating it at 100 to 180° C. for about 5 to 60 min. According to this process, however, when a solution of a coupling agent is applied to both sides of a self-supporting film, adhesiveness may differ between the side of the obtained polyimide film which was in contact with the support when producing the film (side B) and the opposite side which was not in contact with the support (side A).

Meanwhile, with the reduction in size, thickness and weight of electronic devices in recent years, there is the need for the reduction in size of the inner parts. Accordingly, there is the need for a further thinner copper-clad polyimide film, which is used as a flexible printed circuit board (FPC), for example, and therefore, a thinner polyimide film, specifically a polyimide film with a thickness of 20 μm or less, particularly 15 μm or less has come into use. However, the thin polyimide films produced by the above process wherein a solution of a coupling agent is applied to the surface of a self-supporting film of a polyimide precursor solution, and then the self-supporting film is heated to effect imidization, may be of uneven improved adhesiveness. As the effect of improving adhesiveness of a thinner polyimide film may vary relatively widely, a polyimide film with adequately improved adhesiveness is not always obtained by the above process.

Variations in the effect of improving adhesiveness of such a relatively thinner polyimide film, and the difference in adhesiveness between side A and side B of the polyimide film are caused by the following reasons.

A silane coupling agent has an alkoxy group bound to an Si atom, and the alkoxy group reacts with a compound containing an active hydrogen, e.g. water, through a dealcoholization reaction. When modifying the surface properties by applying a solution containing a silane coupling agent to a self-supporting film of a polyimide precursor solution, and then heating it to effect imidization, the surface is modified by the reaction of the coupling agent and water which is generated by the imidization. However, depending on the degree of penetration of the silane coupling agent solution into the self-supporting film, the silane coupling agent may be vaporized without being involved in the reaction, and consequently the desired surface properties and adhesiveness may not be achieved. The degree of penetration of the silane coupling agent solution into the self-supporting film varies subtly according to the amount of the residual solvent in the self-supporting film, the drying temperature, the drying time, and the like. In other words, slight variations in the production process conditions cause variations in the surface properties and adhesiveness of the polyimide film obtained.

Furthermore, the degree of penetration of the silane coupling agent solution into the self-supporting film may vary with the surface state of the film, and may vary according to whether it is the side which was in contact with the support when producing the film (side B) or the opposite side which was not in contact with the support (side A). Thus adhesiveness may differ between side A and side B of the film.

An objective of the present invention is to provide a process for reliably producing a polyimide film with improved adhesiveness by minimizing the variation in adhesiveness of the polyimide film obtained. Another objective of the present invention is to provide a process for producing a polyimide film in which there is little difference in adhesiveness between the side which was in contact with the support when producing the self-supporting film of the polyimide precursor solution (side B) and the opposite side which was not in contact with the support (side A). A further objective of the present invention is to provide a copper-clad polyimide film with high peel strength, which comprises a polyimide film produced by this process.

The present invention relates to the followings.

[1] A process for producing a polyimide film comprising steps of:

applying a solution containing a polyamic acid oligomer having at least one terminal alkoxysilyl group to one side or both sides of a self-supporting film of a polyimide precursor solution; and

heating the self-supporting film with the polyamic acid oligomer to effect imidization; wherein

the polyamic acid oligomer is obtained by the reaction of a tetracarboxylic dianhydride, a diamine, an alkoxysilane compound having a primary amino group at its molecular terminal and, optionally, a monoamine end-capping agent in a molar ratio of X_{A}:X_{B}:X_{C}=2:n:(n−1) and X_{D}:X_{E1}=2:0 to 1:1 wherein X_{A} is the total molar number of the alkoxysilane compound and the end-capping agent (X_{A}=X_{D}+X_{E1}), X_{B} is the molar number of the tetracarboxylic dianhydride, X_{C} is the molar number of the diamine, X_{D} is the molar number of the alkoxysilane compound, X_{E1} is the molar number of the monoamine end-capping agent, and n is a positive number of 1 to 5 [Feature (1)]; and/or

the polyamic acid oligomer is obtained by the reaction of a tetracarboxylic dianhydride, a diamine, an alkoxysilane compound having a dicarboxylic anhydride group at its molecular terminal and, optionally, a dicarboxylic anhydride end-capping agent in a molar ratio of X_{A}:X_{B}:X_{C}=2:(n−1):n and X_{D}:X_{E2}=2:0 to 1:1 wherein X_{A} is the total molar number of the alkoxysilane compound and the end-capping agent (X_{A}=X_{D}+X_{E2}), X_{B} is the molar number of the tetracarboxylic dianhydride, X_{C} is the molar number of the diamine, X_{D} is the molar number of the alkoxysilane compound, X_{E2} is the molar number of the dicarboxylic anhydride end-capping agent, and n is a positive number of 1 to 5 [Feature (2)].

[2] The process for producing a polyimide film as described in [1], wherein the self-supporting film of the polyimide precursor solution is prepared from at least one tetracarboxylic acid component selected from the group consisting of 3,3′,4,4′-biphenyltetracarboxylic dianhydride and pyromellitic dianhydride, and at least one diamine component selected from the group consisting of p-phenylenediamine and 4,4′-diaminodiphenyl ether.

[3] The process for producing a polyimide film as described in [1], wherein part of the alkoxy group bound to an Si atom at the terminal of the polyamic acid oligomer is hydrolyzed in the solution applied to the self-supporting film.

[4] The process for producing a polyimide film as described in [3], wherein the polyamic acid oligomer applied to the self-supporting film is prepared by adding water to the polyamic acid oligomer to hydrolyze part of the alkoxy group bound to an Si atom at its molecular terminal; and the amount of water added is within a range of 25 mol % or less relative to the total amount of the alkoxy group.

[5] A polyimide film produced by the process as described in [1].

[6] A copper-clad polyimide film having a copper layer laminated on the surface of the polyimide film as described in [5], wherein the surface of the polyimide film is the side to which a solution containing the polyamic acid oligomer is applied in producing the polyimide film.

[7] The copper-clad polyimide film as described in [6], wherein the copper layer is formed on the polyimide film by adhering a copper foil with an adhesive.

[8] The copper-clad polyimide film as described in [6], wherein the copper layer is formed on the polyimide film by sputtering or vapor deposition.

[9] The copper-clad polyimide film as described in [6], having a 90° peel strength of 0.7 N/mm or higher.

Herein, 90° peel strength of a copper-clad polyimide film is determined from the 90° peeling test conducted at a pulling speed of 50 mm/min.

According to the present invention, for the purpose of improving adhesiveness of a polyimide film, a solution containing the above-mentioned polyamic acid oligomer having at least one terminal alkoxysilyl group (hereinafter, sometimes referred to as a “silane-modified polyamic acid oligomer”) is applied to one side or both sides of a self-supporting film of a polyimide precursor solution, and then the self-supporting film is heated to imidate the polyimide precursor (polyamic acid) contained in the self-supporting film and the silane-modified polyamic acid oligomer applied onto the surface of the self-supporting film. The solution containing the silane-modified polyamic acid oligomer may be prepared by reacting (amidating) an alkoxysilane compound having a primary amino group at its molecular terminal (a silane coupling agent), a tetracarboxylic dianhydride and a diamine at a given molar ratio in an organic solvent. Alternatively, it may be prepared by reacting (amidating) an alkoxysilane compound having a dicarboxylic anhydride group at its molecular terminal (a silane coupling agent), a tetracarboxylic dianhydride and a diamine at a given molar ratio in an organic solvent.

When applying such a solution of a silane-modified polyamic acid oligomer to a self-supporting film of a polyimide precursor solution, the polyimide oligomer modified with the silane coupling agent, which is derived from the silane-modified polyamic acid oligomer, may be reliably left in the surface of the polyimide film after heating to the amount corresponding to the applied silane-modified polyamic acid oligomer, for example, 95% or more, particularly 97% or more of a theoretical residual ratio, without being influenced by subtle variations in the production process conditions. Accordingly, the effect of improving adhesiveness by the silane coupling agent can be reliably achieved. Furthermore, in contrast to the conventional process, whether it is the side which was in contact with the support when producing the self-supporting film of the polyimide precursor solution (side B) or the opposite side which was not in contact with the support (side A), the polyimide oligomer modified with the silane coupling agent may be reliably left in the polyimide film after heating to the amount corresponding to the applied silane-modified polyamic acid oligomer. Accordingly, there is little or no difference in adhesiveness between side A and side B of the polyimide film obtained.

Thus, according to the present invention, the variation in adhesiveness of the polyimide film obtained may be minimized, and therefore a polyimide film with improved adhesiveness as desired may be reliably produced. Furthermore, the present invention can provide a polyimide film in which there is little difference in adhesiveness between the side which was in contact with the support when producing the self-supporting film of the polyimide precursor solution (side B) and the opposite side which was not in contact with the support (side A).

In addition, the present invention may be easily applied to a thin polyimide film with a thickness of 20 μm or less, further of 15 μm or less, particularly of about 5 μm, for example.

### BRIEF DESCRIPTION OF THE DRAWING

FIG. 1 is a graph showing 90° peel strength of the copper-clad polyimide films having various thickness of the polyimide film obtained in Example 1 and Comparative Example 1.

### DETAILED DESCRIPTION OF THE INVENTION

Owing to its outstanding ability to improve adhesiveness, the polyamic acid oligomer having at least one terminal alkoxysilyl group (polyamic acid oligomer modified with a silane coupling agent) given in the following Feature (1) and/or Feature (2) is used in the present invention.

Feature (1): the polyamic acid oligomer obtained by the reaction of a tetracarboxylic dianhydride, a diamine, an alkoxysilane compound having a primary amino group at its molecular terminal and, optionally, a monoamine end-capping agent in a molar ratio of X_{A}:X_{B}:X_{C}=2:n:(n−1) and X_{D}:X_{E1}=2:0 to 1:1 wherein X_{A} is the total molar number of the alkoxysilane compound and the end-capping agent (X_{A}=X_{D}+X_{E1}), X_{B} is the molar number of the tetracarboxylic dianhydride, X_{C} is the molar number of the diamine, X_{D} is the molar number of the alkoxysilane compound, X_{E1} is the molar number of the monoamine end-capping agent, and n is a positive number of 1 to 5.

In the synthesis of this polyamic acid oligomer, n in the formula: X_{A}:X_{B}:X_{C}=2:n:(n−1) may be preferably a positive number of 1 to 3, more preferably 1 to 2, in view of the degree of improvement in adhesiveness, application property and so on. The ratio of X_{D} to X_{E1} may be preferably X_{D}:X_{E1}=2:0 to 1.3:0.7, more preferably X_{D}:X_{E1}=2:0 to 1.5:0.5, particularly preferably X_{D}:X_{E1}=2:0 to 1.7:0.3.

An example of the silane-modified polyamic acid oligomer having Feature (1) is a compound represented by the following general formula (A):

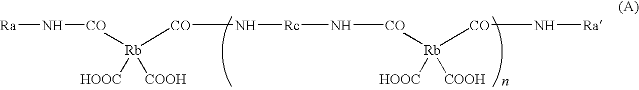

wherein Ra represents a monovalent organic residue having an alkoxysilyl group; Ra′ represents a monovalent organic residue having an alkoxysilyl group, or a monovalent organic residue derived from a monoamine end-capping agent; Rb represents a tetravalent organic residue; Rc represents a divalent organic residue; and n is an arbitrary number representing the average degree of polymerization.

Feature (2): the polyamic acid oligomer obtained by the reaction of a tetracarboxylic dianhydride, a diamine, an alkoxysilane compound having a dicarboxylic anhydride group at its molecular terminal and, optionally, a dicarboxylic anhydride end-capping agent in a molar ratio of X_{A}:X_{B}:X_{C}=2:(n−1):n and X_{D}:X_{E2}=2:0 to 1:1 wherein X_{A} is the total molar number of the alkoxysilane compound and the end-capping agent (X_{A}=X_{D}+X_{E2}), X_{B} is the molar number of the tetracarboxylic dianhydride, X_{C} is the molar number of the diamine, X_{D} is the molar number of the alkoxysilane compound, X_{E2} is the molar number of the dicarboxylic anhydride end-capping agent, and n is a positive number of 1 to 5.

In the synthesis of this polyamic acid oligomer, n in the formula: X_{A}:X_{B}:X_{C}=2:(n−1):n may be preferably a positive number of 1 to 3, more preferably 1 to 2, in view of the degree of improvement in adhesiveness, application property and so on. The ratio of X_{D} to X_{E2} may be preferably X_{D}:X_{E2}=2:0 to 1.3:0.7, more preferably X_{D}:X_{E2}=2:0 to 1.5:0.5, particularly preferably X_{D}:X_{E2}=2:0 to 1.7:0.3.

An example of the silane-modified polyamic acid oligomer having Feature (2) is a compound represented by the following general formula (B):

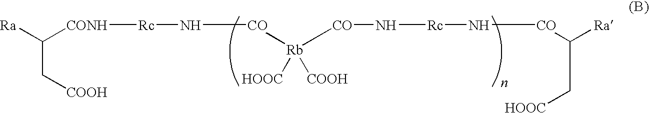

wherein Ra represents a monovalent organic residue having an alkoxysilyl group; Ra′ represents a monovalent organic residue having an alkoxysilyl group, or a monovalent organic residue derived from a dicarboxylic anhydride end-capping agent; Rb represents a tetravalent organic residue; Rc represents a divalent organic residue; and n is an arbitrary number representing the average degree of polymerization.

When n in the above general formula (A) and/or the above general formula (B) is out of the above range, for example, when n is more than 5, the terminal alkoxysilyl group may not be sufficiently introduced into the polyamic acid oligomer to improve adequately the adhesiveness of the polyimide film obtained.

An aromatic tetracarboxylic dianhydride is a preferable tetracarboxylic dianhydride used for forming a polyimide precursor of a self-supporting film and a polyamic acid oligomer. An example of the tetracarboxylic dianhydride used in the present invention is a compound represented by the following general formula (3):

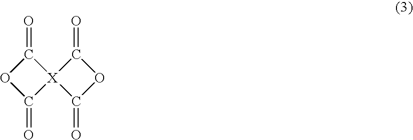

wherein X represents a tetravalent group selected from the groups listed as the following formula (4):

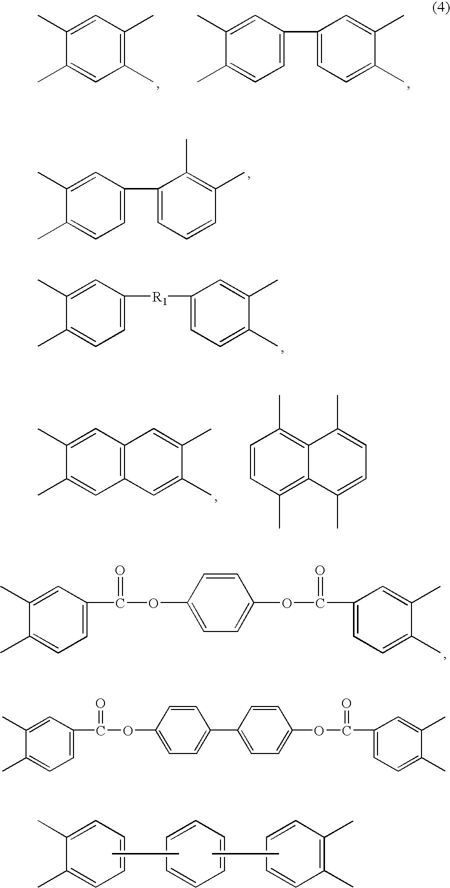

wherein R₁ represents a divalent group selected from the groups listed as the following formula (5):

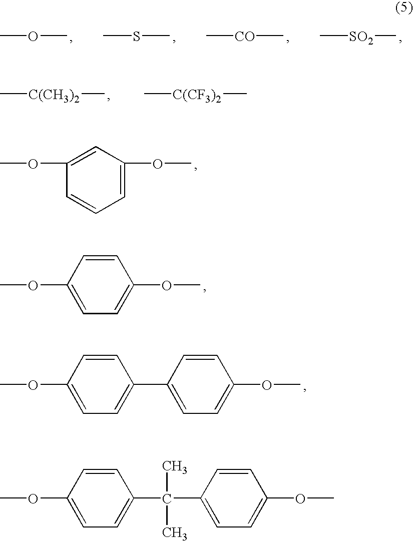

A particularly preferable tetracarboxylic dianhydride may be a compound represented by the following general formula (3′):

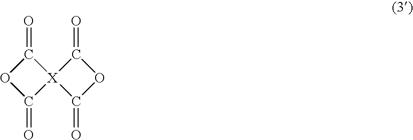

wherein X represents a tetravalent group selected from the groups listed as the following formula (4′):

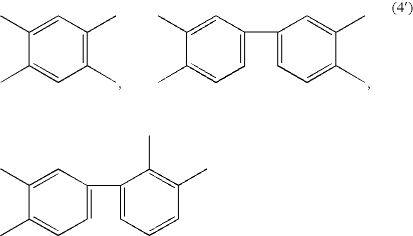

In the present invention, a tetracarboxylic acid component comprising a tetracarboxylic dianhydride represented by the general formula (3), more preferably a tetracarboxylic dianhydride represented by the general formula (3′), as a main component may be used for forming a polyimide precursor and a polyamic acid oligomer. In addition to these tetracarboxylic dianhydrides, other tetracarboxylic dianhydrides may be used, as long as the characteristics of the present invention would not be impaired.

The proportion of the tetracarboxylic dianhydride represented by the general formula (3) in the tetracarboxylic acid component may be preferably 50 mol % or more, more preferably 70 mol % or more, further preferably 80 mol % or more, particularly preferably 90 mol % or more.

Specific examples of the tetracarboxylic dianhydride may include pyromellitic dianhydride, 3,3′,4,4′-biphenyltetracarboxylic dianhydride (s-BPDA), 2,3,3′,4′-biphenyltetracarboxylic dianhydride (a-BPDA), oxydiphthalic dianhydride, diphenyl sulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenone tetracarboxylic dianhydride, 3,3′,4,4′-benzophenone tetracarboxylic dianhydride, bis(3,4-dicarboxyphenyl)methane dianhydride, 2,2-bis(3,4-dicarboxyphenyl)propane dianhydride, p-phenylene bis(trimellitic acid monoester anhydride), p-biphenylene bis(trimellitic acid monoester anhydride), m-terphenyl-3,4,3′,4′-tetracarboxylic dianhydride, p-terphenyl-3,4,3′, 4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride, 2,3,6,7-naphthalene tetracarboxylic dianhydride, 1,4,5,8-naphthalene tetracarboxylic dianhydride, and 4,4′-(2,2-hexafluoroisopropylidene)diphthalic dianhydride. Furthermore, an aromatic tetracarboxylic acid such as 2,3,3′,4′-diphenyl sulfone tetracarboxylic acid may be preferably used. These may be used alone or in combination of two or more. A tetracarboxylic dianhydride used in the present invention may be appropriately selected depending on the desired properties, and the like.

An aromatic diamine, preferably an aromatic diamine having 1 to 3 benzene rings, more preferably having one or two benzene rings, is a preferable diamine used for forming a polyimide precursor of a self-supporting film and a polyamic acid oligomer. An example of the diamine used in the present invention is a compound represented by the following general formula (1):

H₂N—Y—NH₂ (1)

wherein Y represents a divalent group selected from the groups listed as the following formula (2):

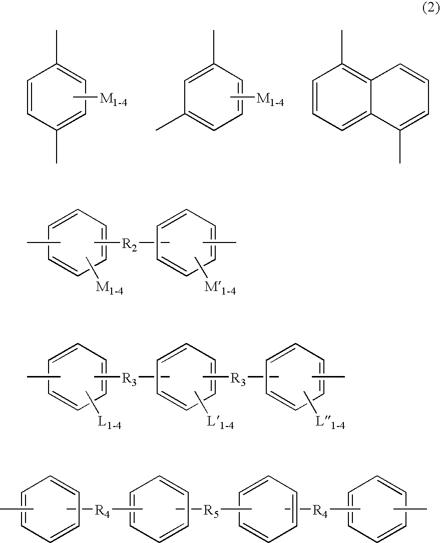

wherein R₂, R₃, R₄ and R₅ independently represent a divalent group selected from the group consisting of a single bond, —O—, —S—, —CO—, —SO₂—, —CH₂—, —C(CH₃)₂— and —C(CF₃)₂—;

M₁-M₄, M′₁-M′₄, L₁-L₄, L′₁-L′₄ and L″₁-L″₄ independently represent —H, —F, —Cl, —Br, —I, —CN, —OCH₃, —OH, —COOH, —CH₃, —C₂H₅ or —CF₃;

R₂, R₃, R₄ and R₅ may be the same or different from each other; and

M₁-M₄, M′₁-M′₄, L₁-L₄, L′₁-L′₄ and L″₁-L″₄ may be the same or different from each other.

A particularly preferable diamine may be a compound represented by the following general formula (1′):

H₂N—Y—NH₂ (1′)

wherein Y represents a divalent group selected from the groups listed as the following formula (2′):

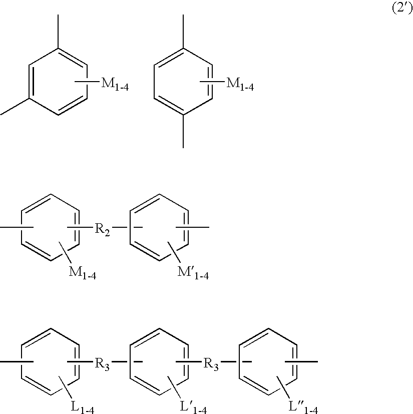

wherein R₂ represents a divalent group selected from the group consisting of a single bond, —O—, —S—, —CH₂— and —C(CH₃)₂—;

R₃ and R₄ independently represent a divalent group selected from the group consisting of —O— and —S—;

R₅ represents a divalent group selected from the group consisting of a single bond, —O—, —CH₂— and —C(CH₃)₂—;

M₁-M₄, M′₁-M′₄, L₁-L₄, L′₁-L′₄ and L″₁-L″₄ independently represent —H or —CH₃;

R₂, R₃, R₄ and R₅ may be the same or different from each other; and

M₁-M₄, M′₁-M′₄, L₁-L₄, L′₁-L′₄ and L″₁-L″₄ may be the same or different from each other.

A further preferable diamine may be a compound represented by the following general formula (1″):

H₂N—Y—NH₂ (1″)

wherein Y represents a divalent group selected from the groups listed as the following formula (2″):

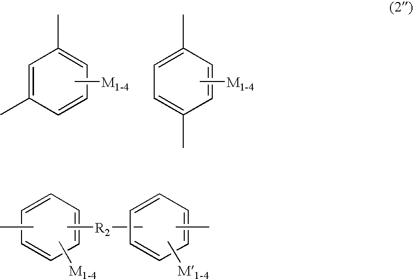

wherein R₂ represents a divalent group selected from the group consisting of a single bond, —O—, —S—, —CH₂— and —C(CH₃)₂—;

M₁-M₄ and M′₁-M′₄ independently represent —H, —OCH₃, —CH₃ or —Cl;

R₂ may be the same or different from each other; and

M₁-M₄ and M′₁-M′₄ may be the same or different from each other.

In the present invention, a diamine component comprising a diamine represented by the general formula (1), more preferably a diamine represented by the general formula (1′), further preferably a diamine represented by the general formula (1″), as a main component may be used for forming a polyimide precursor and a polyamic acid oligomer. The proportion of the diamine represented by the general formula (1), more preferably the diamine represented by the general formula (1′), further preferably the diamine represented by the general formula (1″), in the diamine component may be preferably 50 mol % or more, more preferably 70 mol % or more, further preferably 80 mol % or more, particularly preferably 90 mol % or more.

Specific examples of the diamine may include

1) diamines having one benzene ring such as 1,4-diaminobenzene, 1,3-diaminobenzene, 2,4-diaminotoluene, and 2,6-diaminotoluene;

2) diamines having two benzene rings such as 4,4′-diaminodiphenyl ether, 3,4′-diaminodiphenyl ether, 4,4′-diaminodiphenylmethane, 3,3′-dimethyl-4,4′-diaminobiphenyl, 2,2′-dimethyl-4,4′-diaminobiphenyl, 2,2′-bis(trifluoromethyl) 4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dichlorobenzidine, 3,3′-dimethylbenzidine, 2,2′-dimethylbenzidine, 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, and 4,4′-diaminodiphenyl sulfoxide;

3) diamines having three benzene rings such as 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene, 1,4-bis(4-aminophenoxy)benzene, 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenyl sulfide)benzene, 1,3-bis(4-aminophenyl sulfide)benzene, 1,4-bis(4-aminophenyl sulfide)benzene, 1,3-bis(3-aminophenyl sulfone)benzene, 1,3-bis(4-aminophenyl sulfone)benzene, 1,4-bis(4-aminophenyl sulfone)benzene, 1,3-bis[2-(4-aminophenyl)isopropyl]benzene, 1,4-bis[2-(3-aminophenyl)isopropyl]benzene, and 1,4-bis[2-(4-aminophenyl)isopropyl]benzene; and

4) diamines having four benzene rings such as 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4 (4-aminophenoxy)phenyl]sulfide, bis[3-(3-aminophenoxy)phenyl]sulfone, bis[3-(4 aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane. These may be used alone or in combination of two or more. A diamine used in the present invention may be appropriately selected depending on the desired properties, and the like.

A preferable polyimide precursor may be prepared from an aromatic tetracarboxylic dianhydride and an aromatic diamine.

Among them, preferred is a polyimide precursor prepared from 3,3′,4,4′-biphenyltetracarboxylic dianhydride (hereinafter, sometimes abbreviated as “BPDA”), p-phenylenediamine (hereinafter, sometimes abbreviated as “PPD”) and optionally 4,4′-diaminodiphenyl ether (hereinafter, sometimes abbreviated as “DADE”). In this case, a ratio of PPD/DADE (molar ratio) is preferably 100/0 to 85/15.

And also, preferred is a polyimide precursor prepared from pyromellitic dianhydride (hereinafter, sometimes abbreviated as “PMDA”), or an aromatic tetracarboxylic dianhydride consisting of 3,3′,4,4′-biphenyltetracarboxylic dianhydride and pyromellitic dianhydride, and an aromatic diamine such as benzene diamine and biphenyldiamine. The aromatic diamine may be preferably p-phenylenediamine, an aromatic diamine in which a ratio of PPD/DADE is 90/10 to 10/90, or tolidine (ortho- and meta-types). In this case, a ratio of BPDA/PMDA is preferably 0/100 to 90/10.

In addition, preferred is a polyimide precursor prepared from pyromellitic dianhydride, p-phenylenediamine and 4,4′-diaminodiphenyl ether. In this case, a ratio of DADE/PPD is preferably 90/10 to 10/90.

As described above, the polyamic acid oligomer having at least one terminal alkoxysilyl group used in the present invention is a compound obtained by the reaction of a tetracarboxylic dianhydride, a diamine, an alkoxysilane compound having a primary amino group at its molecular terminal and, optionally, a monoamine end-capping agent at a given molar ratio [as shown in Feature (1)] or a compound obtained by the reaction of a tetracarboxylic dianhydride, a diamine, an alkoxysilane compound having a dicarboxylic anhydride group at its molecular terminal and, optionally, a dicarboxylic anhydride end-capping agent at a given molar ratio [as shown in Feature (2)].

A tetracarboxylic dianhydride and a diamine used for forming a polyamic acid oligomer may have the same composition as, or have a different composition from those used for forming the polyimide precursor of the self-supporting film. A tetracarboxylic dianhydride represented by the above general formula (3) and a diamine represented by the above general formula (1) may be preferably used for forming a polyamic acid oligomer.

An alkoxysilane compound (a silane coupling agent) used in the present invention has an alkoxysilyl group, preferably a trialkoxysilyl group or a dialkoxysilyl group, particularly preferably a trialkoxysilyl group, and has a primary amino group or a dicarboxylic anhydride group at its molecular terminal.

A silane coupling agent having a primary amino group at its molecular terminal may be used for preparing a silane-modified polyamic acid oligomer represented by the above general formula (A). A silane coupling agent having a dicarboxylic anhydride group at its molecular terminal may be used for preparing a silane-modified polyamic acid oligomer represented by the above general formula (B).

The alkoxy group bound to an Si atom in the silane coupling agent may be preferably a straight-chain or branched-chain alkoxy group having 1 to 4 carbon atoms, more preferably methoxy or ethoxy. In the present invention, it is preferable that a part of the alkoxy group bound to an Si atom in the silane coupling agent is hydrolyzed, as described below, and therefore, a methoxy group is more preferable, because it is easily hydrolyzed.

The alkoxysilyl group may be preferably trimethoxysilyl group, dimethoxysilyl group, triethoxysilyl group or diethoxysilyl group, particularly preferably trimethoxysilyl group or dimethoxysilyl group, further preferably trimethoxysilyl group.

In the present invention, any of known aminosilane coupling agents may be used as a silane coupling agent having a primary amino group at its molecular terminal. Preferable examples of the silane coupling agent include γ-aminopropyltrimethoxysilane, γ-aminopropyltriethoxysilane, γ-aminopropylmethyldimethoxysilane, and γ-aminopropyldiethoxysilane. Among them, γ-aminopropyltrimethoxysilane is particularly preferable. These may be used alone or in combination of two or more.

Examples of the silane coupling agent having a dicarboxylic anhydride group at its molecular terminal include γ-trimethoxysilylpropyl succinic anhydride, γ-triethoxysilylpropyl succinic anhydride, γ-dimethoxymethylsilylpropyl succinic anhydride, and γ-diethoxymethylsilylpropyl succinic anhydride. Among them, γ-trimethoxysilylpropyl succinic anhydride is particularly preferable. These may be used alone or in combination of two or more.

Furthermore, an end-capping agent may be used for the synthesis of the silane-modified polyamic acid oligomer of the present invention. A monoamine end-capping agent may be used for preparing a silane-modified polyamic acid oligomer represented by the above general formula (A). A dicarboxylic anhydride end-capping agent may be used for preparing a silane-modified polyamic acid oligomer represented by the above general formula (B).

Examples of the monoamine end-capping agent include aromatic monoamines such as aniline, o-toluidine, m-toluidine, p-toluidine, 2,3-xylidine, 2,6-xylidine, 3,4-xylidine, 3,5-xylidine, o-chloroaniline, m-chloroaniline, p-chloroaniline, o-bromoaniline, m-bromoaniline, p-bromoaniline, o-nitroaniline, p-nitroaniline, m-nitroaniline, o-aminophenol, p-aminophenol, m-aminophenol, o-anisidine, m-anisidine, p-anisidine, o-phenetidine, m-phenetidine, p-phenetidine, o-aminobenzaldehyde, p-aminobenzaldehyde, m-aminobenzaldehyde, o-aminobenznitrile, p-aminobenznitrile, m-aminobenznitrile, 2-aminobiphenyl, 3-aminobiphenyl, 4-aminobiphenyl, 2-aminophenyl phenyl ether, 3-aminophenyl phenyl ether, 4-aminophenyl phenyl ether, 2-aminobenzophenone, 3-aminobenzophenone, 4-aminobenzophenone, 2-aminophenyl phenyl sulfide, 3-aminophenyl phenyl sulfide, 4-aminophenyl phenyl sulfide, 2-aminophenyl phenyl sulfone, 3-aminophenyl phenyl sulfone, 4-aminophenyl phenyl sulfone, α-naphthylamine, β-naphthylamine, 1-amino-2-naphthol, 5-amino-1-naphthol, 2-amino-1-naphthol, 4-amino-1-naphthol, 5-amino-2-naphthol, 7-amino-2-naphthol, 8-amino-1-naphthol, 8-amino-2-naphthol, 1-aminoanthracene, 2-aminoanthracene, and 9-aminoanthracene. Among them, a derivative of aniline may be preferably used. These may be used alone or in combination of two or more.

Examples of the dicarboxylic anhydride end-capping agent include aromatic dicarboxylic anhydrides such as phthalic anhydride, 2,3-benzophenone dicarboxylic anhydride, 3,4-benzophenone dicarboxylic anhydride, 2,3-dicarboxyphenyl phenyl ether anhydride, 3,4-dicarboxyphenyl phenyl ether anhydride, 2,3-biphenyl dicarboxylic anhydride, 3,4-biphenyl dicarboxylic anhydride, 2,3-dicarboxyphenyl phenyl sulfone anhydride, 3,4-dicarboxyphenyl phenyl sulfone anhydride, 2,3-dicarboxyphenyl phenyl sulfide anhydride, 3,4-dicarboxyphenyl phenyl sulfide anhydride, 1,2-naphthalene dicarboxylic anhydride, 2,3-naphthalene dicarboxylic anhydride, 1,8-naphthalene dicarboxylic anhydride, 1,2-anthracene dicarboxylic anhydride, 2,3-anthracene dicarboxylic anhydride, and 1,9-anthracene dicarboxylic anhydride. Among them, phthalic anhydride may be preferably used. These may be used alone or in combination of two or more.

The polyamic acid oligomer having at least one terminal alkoxysilyl group of the present invention may be prepared, for example, by reacting the above-mentioned silane coupling agent, a tetracarboxylic dianhydride and a diamine, or alternatively, the above-mentioned silane coupling agent, a tetracarboxylic dianhydride, a diamine and an end-capping agent at a given molar ratio in an organic solvent at room temperature for about 1 to 10 hours. These components may be reacted simultaneously or sequentially; the silane-modified polyamic acid oligomer can be prepared by either of the following processes:

1) the process wherein the reaction of a tetracarboxylic dianhydride and a diamine is conducted to form a polyamic acid oligomer; and then the polyamic acid oligomer is reacted with a silane coupling agent, or alternatively, a silane coupling agent and an end-capping agent, to prepare a silane-modified polyamic acid oligomer.

2) the process wherein a silane-modified polyamic acid oligomer is prepared by reacting simultaneously a tetracarboxylic dianhydride, a diamine, and a silane coupling agent, or alternatively, a silane coupling agent and an end-capping agent.

The reaction temperature for the synthesis of the polyamic acid oligomer may be preferably about 0 to 80° C., more preferably about 0 to 60° C., particularly preferably about 0 to 50° C. The organic solvent used for the synthesis of the polyamic acid oligomer may be appropriately selected from any known organic solvents used in the production of aromatic polyimides and polyimide precursors. Specific examples of the organic solvent may include N,N-dimethylacetamide, N,N-diethylacetamide, N,N-dimethylformamide, N,N-diethylformamide and N-methyl-2-pyrrolidone.

It is not necessary to separate the obtained silane-modified polyamic acid oligomer from the organic solvent after the synthesis reaction. The obtained solution of the silane-modified polyamic acid oligomer in the organic solvent may be applied to a self-supporting film, without isolation, after removing or adding a solvent, if necessary.

According to the present invention, a solution containing the above-mentioned polyamic acid oligomer having at least one terminal alkoxysilyl group is applied to one side or both sides of a self-supporting film of a polyimide precursor solution, and then the self-supporting film is heated to effect imidization, thereby forming a polyimide film.

A self-supporting film of a polyimide precursor solution may be prepared by flow-casting a solution of a polyimide precursor in an organic solvent to give a polyimide on a support, after adding an imidization catalyst, an organic phosphorous compound and/or an inorganic fine particle to the solution, if necessary, and then heating it sufficiently to make it self-supporting, which means a stage before a common curing process.

A polyimide precursor can be synthesized by random-polymerizing or block-polymerizing substantially equimolar mixture of an aromatic tetracarboxylic dianhydride and an aromatic diamine in an organic solvent. Alternatively, two or more polyimide precursors in which either of these two components is excessive may be prepared, and subsequently, these polyimide precursor solutions may be combined and then mixed under reaction conditions. The polyimide precursor solution thus obtained may be used without any treatment, or may be used after removing or adding a solvent, if necessary, to prepare a self-supporting film.

Examples of an organic solvent for the polyimide precursor solution include N-methyl-2-pyrrolidone, N,N-dimethylformamide, N,N-dimethylacetamide and N,N-diethylacetamide. These organic solvents may be used alone or in combination of two or more.

The polyimide precursor solution may contain an imidization catalyst, a dehydration reaction auxiliary, an organic phosphorous-containing compound, an inorganic fine particle, and the like, if necessary.

Examples of the imidization catalyst include substituted or unsubstituted nitrogen-containing heterocyclic compounds, N-oxide compounds of the nitrogen-containing heterocyclic compounds, substituted or unsubstituted amino acid compounds, hydroxyl-containing aromatic hydrocarbon compounds, and aromatic heterocyclic compounds. Particularly suitable examples of the imidization catalyst used are lower-alkylimidazoles such as 1,2-dimethylimidazole, N-methylimidazole, N-benzyl-2-methylimidazole, 2-methylimidazole, 2-ethyl-4-imidazole and 5-methylbenzimidazole; benzimidazoles such as N-benzyl-2-methylimidazole; and substituted pyridines such as isoquinoline, 3,5-dimethylpyridine, 3,4-dimethylpyridine, 2,5-dimethylpyridine, 2,4-dimethylpyridine and 4-n-propylpyridine. The amount of the imidization catalyst used is preferably about 0.01 to 2 equivalents, particularly preferably about 0.02 to 1 equivalents relative to the amount of an amide acid unit in a polyamide acid. The use of the imidization catalyst is preferable because the polyimide film obtained has the improved properties, particularly extension and edge-cracking resistance.

Examples of the organic phosphorous-containing compound include phosphates such as monocaproyl phosphate, monooctyl phosphate, monolauryl phosphate, monomyristyl phosphate, monocetyl phosphate, monostearyl phosphate, triethyleneglycol monotridecyl ether monophosphate, tetraethyleneglycol monolauryl ether monophosphate, diethyleneglycol monostearyl ether monophosphate, dicaproyl phosphate, dioctyl phosphate, dicapryl phosphate, dilauryl phosphate, dimyristyl phosphate, dicetyl phosphate, distearyl phosphate, tetraethyleneglycol mononeopentyl ether diphosphate, triethyleneglycol monotridecyl ether diphosphate, tetraethyleneglycol monolauryl ether diphosphate, and diethyleneglycol monostearyl ether diphosphate; and amine salts of these phosphates. Examples of the amine include ammonia, monomethylamine, monoethylamine, monopropylamine, monobutylamine, dimethylamine, diethylamine, dipropylamine, dibutylamine, trimethylamine, triethylamine, tripropylamine, tributylamine, monoethanolamine, diethanolamine and triethanolamine.

The dehydration reaction auxiliary used in the present invention may be appropriately selected from any known agents for assisting the dehydration reaction of a polyimide precursor to form a polyimide. Specific examples of the dehydration reaction auxiliary may include pyridine, α-picoline, β-picoline and isoquinoline.

Examples of the inorganic fine particle include particulate inorganic oxide powders such as titanium dioxide powder, silicon dioxide (silica) powder, magnesium oxide powder, aluminum oxide (alumina) powder and zinc oxide powder; particulate inorganic nitride powders such as silicon nitride powder and titanium nitride powder; inorganic carbide powders such as silicon carbide powder; and particulate inorganic salt powders such as calcium carbonate powder, calcium sulfate powder and barium sulfate powder. These inorganic fine particles may be used in combination of two or more. These inorganic fine particles can be homogeneously dispersed using the known means.

A self-supporting film of a polyimide precursor solution is prepared by flow-casting and applying the above-mentioned solution of a polyimide precursor in an organic solvent, or a polyimide precursor solution composition which is prepared by adding an imidization catalyst, a dehydration reaction auxiliary, an organic phosphorous-containing compound, an inorganic fine particle, and the like to the above solution, on a support, and then heating it to the extent that the film becomes self-supporting, which means a stage before a common curing process, for example, to the extent that the film can be peeled from the support; specifically, heating it at 100 to 180° C., preferably 100 to 160° C., more preferably 100 to 140° C., for about 2 to 60 min, preferably about 2 to 30 min, more preferably about 2 to 10 min, particularly preferably about 2 to 5 min.

In the present invention, a preferable self-supporting film of a polyimide precursor solution may be one prepared at a low heating temperature, more preferably a self-supporting film prepared at a low heating temperature and having a relatively low imidization rate. When applying a solution containing a silane-modified polyamic acid oligomer to such a self-supporting film, the better effect can be achieved.

The content of the polyimide precursor in the polyimide precursor solution may be preferably about 8 to 30% by weight, more preferably about 8 to 25% by weight.

A substrate having a smooth surface may be preferably used as a support for a self-supporting film of a polyimide precursor solution. The support used may be a stainless substrate or a stainless belt, for example

In the present invention, a silane-modified polyamic acid oligomer solution should be substantially uniformly, preferably uniformly and evenly, applied to one side or both sides of a peeled self-supporting film, irrespective of whether the applied portion is a part of, or the whole of the surface, or the whole of the surface except for both ends. Thus, the self-supporting film should be a film to one side or both sides of which a silane-modified polyamic acid oligomer solution can be applied substantially uniformly, preferably uniformly and evenly, and a film in which no flaws and cracks are observed after applying a silane-modified polyamic acid oligomer solution; and therefore, the heating conditions such as a heating temperature and a heating time should be appropriately selected to give such a film. For preparing such a film, it is necessary to control a solvent contained in the self-supporting film and imidization of the polyimide precursor.

It is preferable that a weight loss on heating is within a range of 20 to 40% by weight, and it is further preferable that a weight loss on heating is within a range of 20 to 40% by weight and an imidization rate is within a range of 8 to 40%, by reason that the self-supporting film obtained has sufficient mechanical properties, a silane-modified polyamic acid oligomer solution is evenly applied to the surface of the self-supporting film more easily, and no foaming, flaws, crazes, cracks and fissures are observed in the polyimide film obtained after imidating.

The weight loss on heating of a self-supporting film as described above is calculated by the following numerical equation (1) from the weight before drying (W1) and the weight after drying (W2) of the film to be measured which is dried at 420° C. for 20 min.

Weight loss on heating (% by weight)={(W1−W2)/W1}×100 (1)

The imidization rate of a self-supporting film as described above can be calculated based on the ratio of the vibration band peak area measured with IR spectrometer (ATR) between the film and a fully-cured product. The vibration band peak utilized in the procedure may include a symmetric stretching vibration band of an imide carbonyl group and a skeletal stretching vibration band of a benzene ring. The imidization rate can be also determined in accordance with the procedure described in Japanese Laid-open Patent Publication No. 1997-316199, using a Karl Fischer moisture meter.

In the present invention, a self-supporting film of a polyimide precursor solution may be prepared by, in addition to the thermal imidization as described above, the chemical imidization, or a combination of thermal imidization and chemical imidization.

According to the present invention, a solution containing a polyamic acid oligomer having at least one terminal alkoxysilyl group (a silane-modified polyamic acid oligomer) as described above in an organic solvent, which preferably contains substantially no water, is applied to one side or both sides of the self-supporting film thus obtained.

Examples of the organic solvent for the silane-modified polyamic acid oligomer solution may include those listed as the organic solvent for the polyimide precursor solution (the solvent contained in the self-supporting film). The preferable organic solvent is a solvent compatible with the polyimide precursor solution, and is the same as the organic solvent for the polyimide precursor solution. The organic solvent may be a mixture of two or more compounds.

The concentration of the silane-modified polyamic acid oligomer in the applied solution (application solution) may be preferably 0.1 to 10% by weight, particularly preferably 1 to 3% by weight. When the concentration of the silane-modified polyamic acid oligomer is less than 0.1% by weight, the sufficient effect may not be achieved. On the other hand, when the concentration of the silane-modified polyamic acid oligomer is too high, a polyimide layer derived from the silane-modified polyamic acid oligomer at the surface of the film may be too thick, and the toughness of the polyimide film obtained may decrease.

In the present invention, the solution of a silane-modified polyamic acid oligomer, which is applied to the self-supporting film, preferably contains substantially no water. When the application solution contains a large amount of water, the surface tension of the application solution may be so high that a self-supporting film repels the solution, and/or an imidization reaction of a polyamic acid may be inhibited, leading to deterioration in the properties of the polyimide film obtained.

A solution of a silane-modified polyamic acid oligomer in an organic solvent preferably has a rotational viscosity (a solution viscosity measured with a rotation viscometer at a measurement temperature of 25° C.) of 1 to 50,000 centipoise.

Although the sufficient effect may be achieved when applying a silane-modified polyamic acid oligomer to a self-supporting film of a polyimide precursor solution without any treatment, it is preferable that a part of the alkoxy group bound to an Si atom is hydrolyzed prior to applying it to the self-supporting film. The alkoxy-group hydrolysis rate (the proportion of the hydrolyzed alkoxy group) is preferably 5% to 25%, more preferably 10% to 18%. When the alkoxy-group hydrolysis rate is less than 5%, the sufficient effect may not be achieved. On the other hand, when the alkoxy-group hydrolysis rate is more than 25%, the solution stability may deteriorate.

Such an application solution can be prepared by adding water in an amount required for the hydrolysis of the alkoxy group to a solution of a silane-modified polyamic acid oligomer in an organic solvent, to hydrolyze the alkoxy group bound to an Si atom; and then, if necessary, adding an organic solvent to the resulting solution. A hydroxysilane and a corresponding alcohol are formed by the hydrolysis of the alkoxy group.

The amount of water added for the hydrolysis is the minimum amount required for the hydrolysis of the alkoxy group at the desired rate, and may be preferably within a range of 5 to 25 mol %, more preferably 10 to 18 mol %, relative to the total amount of the alkoxy group in the silane-modified polyamic acid oligomer. In the present invention, water is preferably added so that the solution contains substantially no water when it is applied to the surface of the self-supporting film after hydrolysis.

Although the hydrolysis reaction of the alkoxy group in the silane-modified polyamic acid oligomer may be conducted in a solution containing the same concentration of the silane-modified polyamic acid oligomer as the application solution, owing to low concentration of the silane-modified polyamic acid oligomer, it may require the relatively long reaction time. Therefore, it is preferable that the hydrolysis reaction is conducted using a solution containing a silane-modified polyamic acid oligomer at 10 to 40% by weight, preferably 15 to 35% by weight as a starting reaction solution; and after the reaction, an organic solvent is added to the resulting solution, thereby adjusting the concentration of the silane-modified polyamic acid oligomer, to give a application solution. The hydrolysis reaction may be conducted at a reaction temperature of 40 to 100° C., preferably 50 to 70° C. for about 1 to 10 hours.

Furthermore, a surfactant may be added to the solution containing the silane-modified polyamic acid oligomer so as to prevent repelling or grazing of the solution during application. Examples of the surfactant include silicon surfactants, fluorine surfactants, and hydrocarbon surfactants. A particularly preferable surfactant may be volatile at high temperature. Another additive component may be added to the solution, if necessary.

The application amount of the solution containing the silane-modified polyamic acid oligomer may be appropriately determined, and is preferably 1 to 50 g/m², more preferably 2 to 30 g/m², particularly preferably 3 to 20 g/m² for both the side of the self-supporting film which was in contact with the support, and the opposite side. The application amount of the silane-modified polyamic acid oligomer solution to one side may be the same as, or different from the application amount of the silane-modified polyamic acid oligomer solution to the other side.

The solution containing the silane-modified polyamic acid oligomer can be applied by any known method; for example, by gravure coating, spin coating, silk screen process, dip coating, spray coating, bar coating, knife coating, roll coating, blade coating, and die coating.

According to the present invention, the self-supporting film on which a silane-modified polyamic acid oligomer solution is applied is then heated to give a polyimide film.

The preferable heat treatment may be a process where polymer imidization and solvent evaporation/removal are gradually conducted at about 100 to 400° C. for about 0.05 to 5 hours, particularly 0.1 to 3 hours as the first step. This heat treatment is particularly preferably conducted stepwise, that is, the first heat treatment at a relatively lower temperature of about 100 to 170° C. for about 0.5 to 30 min, then the second heat treatment at 170 to 220° C. for about 0.5 to 30 min, and then the third heat treatment at a high temperature of 220 to 400° C. for about 0.5 to 30 min. If necessary, the fourth high-temperature heat treatment at 400 to 550° C. may be conducted. In continuous heat treatment at 250° C. or higher, it is preferable that at least both edges of a long solidified film in the direction perpendicular to the direction of the length are fixed with a pintenter, a clip or a frame, for example, while heating. The heat treatment may be conducted using a known apparatus such as a hot-air oven and an infrared heating oven.

Although there are no particular restrictions to the thickness of the polyimide film obtained according to the present invention, it may be preferably 150 μm or less, more preferably 5 to 120 μm. Furthermore, the more remarkable effect may be obtained when the present invention is applied to the production of a polyimide film with a thickness of 30 μm or less, further of 15 μm or less, particularly 5 μm to 10 μm.

A polyimide film obtained according to the present invention has improved adhesiveness, sputtering properties, and vapor deposition properties. Therefore, a metal foil such as a copper foil can be attached with an adhesive onto the side to which a silane-modified polyamic acid oligomer solution is applied, to give a metal-clad polyimide film such as a copper-clad polyimide film having excellent adhesiveness and sufficiently high peel strength. Alternatively, a metal layer such as a copper layer can be formed by sputtering or vapor deposition on the side to which a silane-modified polyamic acid oligomer solution is applied, to give a metal-clad polyimide film such as a copper-clad polyimide film having excellent adhesiveness and sufficiently high peel strength. A metal layer can be laminated onto a polyimide film by a known method.

A polyimide film obtained according to the present invention, preferably the side having the polyimide layer derived from the silane-modified polyamic acid oligomer, may be subjected to surface treatment such as corona discharge treatment, low-temperature plasma discharge treatment, atmospheric plasma discharge treatment, and chemical etching, for example, before use.

A metal-clad polyimide film may be prepared by forming a metal layer by a metallizing method on the polyimide film obtained according to the present invention, preferably the side having the polyimide layer derived from the silane-modified polyamic acid oligomer.

Furthermore, a metal-plated layer can be formed on the metal layer of the metal-clad polyimide film by a metal plating method such as copper plating, to give a metal-plated polyimide film.

The metal layer formed by a metallizing method may be any metal layer, as long as it has sufficient adhesiveness to the polyimide film, preferably the side having the polyimide layer derived from the silane-modified polyamic acid oligomer, and sufficient adhesiveness to the metal-plated layer formed thereon, with no practical problem.

The metallizing method is a method for forming a metal layer which is different from metal plating or metal foil lamination, and may include any known method such as vapor deposition, sputtering, ion plating and electron-beam evaporation.

Examples of a metal used in the metallizing method include, but not limited to, metals such as copper, nickel, chromium, manganese, aluminum, iron, molybdenum, cobalt, tungsten, vanadium, titanium and tantalum, and alloys thereof, oxides thereof, and carbides thereof.

A thickness of a metal layer formed by a metallizing method may be appropriately determined depending on an intended application, and is preferably 1 to 500 nm, more preferably 5 to 200 nm for a practical use.

The number of metal layers formed by a metallizing method may be appropriately determined depending on an intended application, and may be one, two, three or more layers.

On the surface of the metal layer of the metal-clad polyimide film, a metal-plated layer such as a copper-plated layer and a tin-plated layer can be formed by a known wet plating process such as electrolytic plating or nonelectrolytic plating.

A metal-clad polyimide film preferably has a metal-plated layer such as a copper-plated layer with a thickness of 1 to 40 μm for a practical use.

A metal-clad polyimide film may be prepared by laminating a metal foil on one side or both sides of the polyimide film of the present invention, preferably the side having the polyimide layer derived from the silane-modified polyamic acid oligomer, directly or via an adhesive layer.

A metal-clad polyimide film may be prepared, for example, by continuously pressing, or heating and pressing a polyimide film and a metal foil by a pair of pressing members.

Examples of the pressing member include a pair of press metal rolls in which the press part may be made of either a metal or a ceramic sprayed coating metal, a double-belt press, and a hot-press. A preferable pressing member may be one capable of conducting thermo-compression bonding and cooling under pressure, and a hydraulic-press type double-belt press is particularly preferable.

In the present invention, any of heat-resistant adhesives commonly used in electronics field may be used for adhering a metal foil to a polyimide film, without limitation. Examples of the adhesive include polyimide adhesives, epoxy-modified polyimide adhesives, phenol-resin-modified epoxy resin adhesives, epoxy-modified acrylic resin adhesives, and epoxy-modified polyamide adhesives. These adhesives may be used according to any of methods used in electronics field. For example, an adhesive solution may be applied on the polyimide film of the present invention, preferably the side having the polyimide layer derived from the silane-modified polyamic acid oligomer, followed by drying. Alternatively, an adhesive film separately formed may be laminated onto the polyimide film of the present invention, preferably the side having the polyimide layer derived from the silane-modified polyamic acid oligomer.

A metal foil used in the present invention may be made of either a single metal or an alloy. Specific examples of the metal foil include a copper foil, an aluminum foil, a gold foil, a silver foil, a nickel foil and a stainless steel foil. A copper foil such as a rolled copper foil and an electrolytic copper foil may be suitably used. Although there are no particular restrictions to the thickness of the metal foil, it may be preferably 0.1 μm to 10 mm, more preferably 1 to 35 μm, particularly preferably 5 to 18 μm.

When using an ultrathin copper foil having a thickness of 1 μm to 10 μm as a substrate, a copper foil with a carrier may be suitably used, in view of its superior handling property. Preferable examples of the carrier include, but not limited to, a rolled copper foil and an electrolytic copper foil having a thickness of 5 to 150 μm. It is preferable that the carrier can be mechanically peeled from the ultrathin copper foil easily, and a copper foil with a carrier may preferably have a peel strength of 0.01 to 0.3 N/mm.

According to the present invention, there may be provided, for example, a copper-clad polyimide film having a 90° peel strength of 0.7 N/mm or higher, particularly 0.8 N/mm or higher, further 0.9 N/mm or higher, and a thickness of the polyimide film comprised therein of 30 μm or less, particularly 15 μm or less, further 10 μm or less. A thickness of a polyimide film may be preferably about 5 μm to 15 μm. A thickness of a copper layer may be appropriately determined depending on an intended application, and is preferably about 1 μm to 20 μm.

The polyimide film and the metal-clad polyimide film of the present invention may be used as a material for an electronic parts and an electronic device including a printed circuit board, a flexible printed board, a tape for TAB and a tape for COF.

The polyimide film of the present invention may preferably have a tensile modulus (MD) of 6 to 12 GPa and a linear expansion coefficient (50 to 200° C.) of 10×10⁻⁶ to 30×10⁻⁶ cm/cm/° C., for use as a material for an electronic parts and an electronic device including a printed circuit board, a flexible printed board, a tape for TAB and a tape for COF.

### EXAMPLES

The present invention will be more specifically described with reference to the following Examples. However, the present invention is not limited to these Examples.

### Reference Example 1

### Preparation of a Silane-Modified Polyamic Acid Oligomer Solution

To a solution of γ-aminopropyltrimethoxysilane (Shin-Etsu Chemical Co., Ltd.; KBM903) in N,N-dimethylacetamide was added 3,3′,4,4′-biphenyltetracarboxylic dianhydride (s-BPDA) in a molar ratio of KBM903:s-BPDA=2:1, and the resulting mixture was reacted at room temperature, to prepare a solution containing a silane-modified polyamic acid oligomer represented by the following formula (A1) with a solid content of 20% by weight.

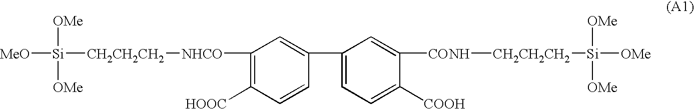

To the solution of the silane-modified polyamic acid oligomer in N,N-dimethylacetamide thus obtained was added water in the amount shown in Table 1, and the resulting mixture was reacted at 60° C. for 5 hours, to partially hydrolyze the alkoxy group bound to an Si atom. The partially-hydrolyzed silane coupling agent solution thus obtained was used as a stock solution for application.

To the stock solution thus obtained was added N,N-dimethylacetamide, to prepare a solution containing a silane-modified polyamic acid oligomer with a solid content of 1% by weight, which was used as an application solution.

Evaluation of Hydrolytic Stability of the Silane-Modified Polyamic Acid Oligomer Solution

The hydrolytic stability of the solution of the silane-modified polyamic acid oligomer in N,N-dimethylacetamide (solid content: 20 wt %) was evaluated from the occurrence of gelation after heating at 60° C. for 5 hours with a given amount of water added. The results are shown in Table 1. In Table 1, the amounts of added water are expressed as an equivalent to the total amount of the alkoxy group in the silane-modified polyamic acid oligomer.

TABLE 1

| Amount of added water | 1/6 | 1.4/6 | 2/6 | 6/6 |
|---|---|---|---|---|
| Stability of solution | Stable | Stable | Gelation | Gelation |

Unless otherwise specified, the solution of the silane-modified polyamic acid oligomer in the Examples has an alkoxy-group hydrolysis rate of 17%, which corresponds to the hydrolysis of 1 mole per 6 mole of the methoxy group present in the silane-modified polyamic acid oligomer, and the application solution was prepared by diluting the 20 wt % stock solution with N,N-dimethylacetamide.

Evaluation of Residual Ratio of the Silane Coupling Agent

When the partially hydrolyzed silane-modified polyamic acid oligomer solution prepared as described above (the stock solution) was heated at 450° C. for 3 min, 14.4% by weight of an imide component and a silica component remained (a theoretical residual ratio: 14.66% by weight).

In contrast, when a solution of N-phenyl-γ-aminopropyltrimethoxysilane, which is a conventional silane coupling agent, in N,N-dimethylacetamide with a solid content of 20% by weight was heated at 450° C. for 3 min as described above, a small amount of SiO₂ remained. When heating the solution at 200° C. for 3 min, a small amount of SiO₂ remained.

### Example 1

Into a polymerization tank were placed a given amount of N,N-dimethylacetamide, 3,3′,4,4′-biphenyltetracarboxylic dianhydride, and p-phenylenediamine in this order. And then, the resulting mixture was polymerized at 30° C. for 10 hours, to give a polyimide precursor solution having a polymer inherent viscosity (measurement temperature: 30° C., concentration: 0.5 g/100 mL solvent, solvent: N,N-dimethylacetamide) of 1.60 and a polymer concentration of 18% by weight. To the polyimide precursor solution was added 2.4 parts by weight of 1,2-dimethylimidazole relative to 100 parts by weight of the polyimide precursor, and the resulting mixture was homogeneously mixed to give a polyimide precursor solution composition. The polyimide precursor solution composition had a rotational viscosity of 3,000 poise.

The polyimide precursor solution composition thus obtained was applied on a glass plate as a support, to form a thin film on the support. The thin film was heated at 135° C. for 3 min, and then peeled off from the support to give a self-supporting film.

On side A or side B of this self-supporting film was applied the application solution prepared as described in Reference Example 1 (solid content: 1 wt %; the amount of added water: 1/6 equivalent to the total amount of the alkoxy group in the silane-modified polyamic acid oligomer) with a bar coater. The application amount was 14 g/m² And then, the film was dried on a hot plate. Subsequently, the dried film was fed into a continuous heating oven while fixing both edges of the film in the width direction, and the film was imidized by heating under the conditions of the highest heating temperature in the oven of about 450° C. for 3 min, to prepare a polyimide film. This process was repeated, to prepare polyimide films having various thicknesses.

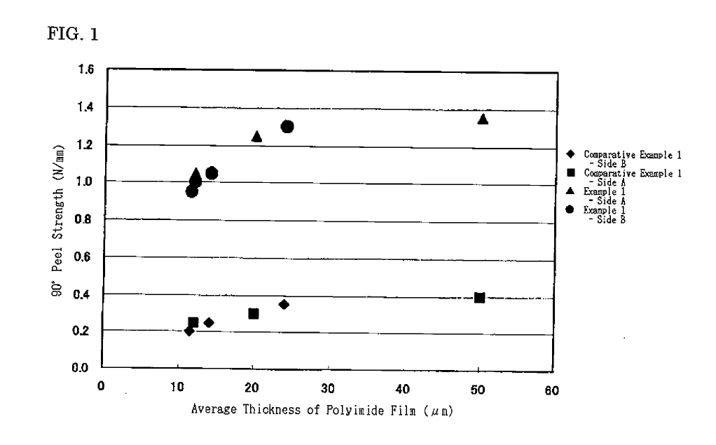

The polyimide film thus obtained, an adhesive sheet (Du Pont, Pyralux LF; thickness: 25 μm) and a rolled copper foil (Nikko Materials Co., Ltd., BHY-13H-T; thickness: 18 μm) were laminated, and the laminate was hot-pressed at 180° C. for 1 min and then heated at 180° C. for 1 hour, to prepare a copper-clad polyimide film. For the copper-clad polyimide film thus obtained, its 90° peel strength was determined. The measurement results are shown in FIG. 1.

### Comparative Example 1

A copper-clad polyimide film was prepared in the same way as Example 1, except that the silane-modified polyamic acid oligomer solution was not applied on the self-supporting film. And, for the copper-clad polyimide film thus obtained, its 90° peel strength was determined. The measurement results are shown in FIG. 1.

As seen from FIG. 1, the copper-clad polyimide films of Example 1, i.e. the copper-clad polyimide films of the present invention prepared by applying the silane-modified polyamic acid oligomer solution on the self-supporting film, had a 90° peel strength of about 1 N/mm or higher, even for the copper-clad polyimide film comprising the thin polyimide film with a thickness of 12.5 μm. Furthermore, there was little difference in 90° peel strength between side A and side B.

### Example 2

An application solution was prepared in the same way as Reference Example 1, except that pyromellitic dianhydride (PMDA) was used instead of 3,3′,4,4′-biphenyltetracarboxylic dianhydride (s-BPDA). And, using this application solution, a copper-clad polyimide film was prepared in the same way as Example 1, and its 90° peel strength was determined. This copper-clad polyimide film had a nearly equal 90° peel strength to the copper-clad polyimide film of Example 1.

### Example 3

An application solution was prepared in the same way as Reference Example 1, except that the amount of water added for the hydrolysis was 1.4/6 equivalent to the total amount of the alkoxy group in the silane-modified polyamic acid oligomer. And, using this application solution, a copper-clad polyimide film was prepared in the same way as Example 1, and its 90° peel strength was determined. This copper-clad polyimide film had a nearly equal 90° peel strength to the copper-clad polyimide film of Example 1.

### Example 4

An application solution was prepared in the same way as Reference Example 1, except that the solid content of the application solution was 3% by weight. And, using this application solution, a copper-clad polyimide film was prepared in the same way as Example 1, and its 90° peel strength was determined. This copper-clad polyimide film had a nearly equal 90° peel strength to the copper-clad polyimide film of Example 1.

### Example 5

The application solutions having the compositions (the charge ratio of the raw materials for the silane-modified polyamic acid oligomer production) and the concentrations shown in Table 2 were prepared in the same way as Reference Example 1, and the copper-clad polyimide films comprising the polyimide films with a thickness of 25 μm were prepared in the same way as Example 1, using these application solutions. For the copper-clad polyimide films thus obtained, 90° peel strength were determined. The measurement results are shown in Table 2.

In Table 2, ODA represents 4,4′-diaminodiphenyl ether.

TABLE 2

| Composition of | Concentration of | | 90° peel |
|---|---|---|---|
| Application solution | Application solution | Applied | strength |
| s-BPDA/ODA/KBM903 | (wt %) | Side | (N/mm) |
| 1/0/2 | 1 | side A | 1.3 |
| | | side B | 1.25 |
| | 3 | side A | 1.3 |
| | | side B | 1.3 |
| 1.5/0.5/2 | 1.5 | side B | 1.3 |
| | 2 | side B | 1.2 |
| 2/1/2 | 1 | side A | 1.4 |
| | | side B | 1.2 |
| | 2 | side B | 1.35 |
| | 3 | side B | 1.25 |

### Reference Example 2

A copper-clad polyimide film comprising a polyimide film with a thickness of 12.5 μm was prepared in the same way as Example 1, except that a 1 wt % solution of a conventional silane coupling agent (N-phenyl-γ-aminopropyltrimethoxysilane) in ethanol was used as an application solution. As the measurement result, the copper-clad polyimide film having the copper foil on side A had a 90° peel strength of 0.6 N/mm, and the copper-clad polyimide film having the copper foil on side B had a 90° peel strength of 0.5 N/mm.

### Example 6

### Preparation of an Application Solution

To 670 g of N,N-dimethylacetamide were added 89.67 g of γ-aminopropyltrimethoxysilane (KBM903) and 73.53 g of 3,3′,4,4′-biphenyltetracarboxylic dianhydride (s-BPDA), and the resulting mixture was reacted at room temperature for about 1 hour. Then, to the solution of the silane coupling agent in N,N-dimethylacetamide thus obtained was added 4.5 g of water, and the resulting mixture was reacted at 60° C. for 1.5 hours. And then, to the solution thus obtained was added N,N-dimethylacetamide, to prepare a silane-modified polyamic acid oligomer solution with a solid content of 10% by weight, which was used as an application solution.

When this silane-modified polyamic acid oligomer solution was heated at 450° C. for 3 min, 7.2% by weight of an imide component and a silica component remained (a theoretical residual ratio: 7.33% by weight).

Preparation of a Copper-Clad Polyimide Film

The polyimide precursor solution composition prepared in the same way as Example 1 was continuously casted from a slit of a T-die mold and extruded on a smooth metal support in a drying oven, to form a thin film on the support. The thin film was heated at 120 to 160° C. for 5 min, and then peeled off from the support to give a self-supporting film.

On side A (the side which was not in contact with the support) of this self-supporting film was continuously applied the application solution at the application amount of 5 g/m² with a die coater. And then, the film was dried under hot air at 80 to 120° C. Subsequently, the dried film was fed into a continuous heating oven while fixing both edges of the film in the width direction, and the film was imidized by heating under the conditions of the highest heating temperature in the oven of about 450° C. for 5 min, to prepare a long polyimide film having an average thickness of 25 μm and a width of 524 mm continuously.

On the polyimide film thus obtained was laminated a rolled copper foil in the same way as Example 1, to prepare a copper-clad polyimide film. As the measurement result, the copper-clad polyimide film had a 90° peel strength of 1.2 N/mm. Furthermore, the variation was within the range of +0.1 N/mm to 0.05 N/mm, and no hunting was observed, the copper-clad polyimide film had a very stable strength.

As described above, according to the present invention, the variation in adhesiveness of the polyimide film obtained may be minimized, and therefore a polyimide film with improved adhesiveness may be reliably produced, especially when producing a thin polyimide film. Furthermore, according to the present invention, there can be provided a polyimide film in which there is little difference in adhesiveness between the side which was in contact with the support when producing the self-supporting film of the polyimide precursor solution (side B) and the opposite side which was not in contact with the support (side A).

What is claimed is:

1. A process for producing a polyimide film comprising steps of:
applying a solution containing a polyamic acid oligomer having at least one terminal alkoxysilyl group to one side or both sides of a self-supporting film of a polyimide precursor solution; and
heating the self-supporting film with the polyamic acid oligomer to effect imidization; wherein
the polyamic acid oligomer is obtained by the reaction of a tetracarboxylic dianhydride, a diamine, an alkoxysilane compound having a primary amino group at its molecular terminal and, optionally, a monoamine end-capping agent in a molar ratio of X_{A}:X_{B}:X_{C}=2:n:(n−1) and X_{D}:X_{E1}=2:0 to 1:1 wherein X_{A} is the total molar number of the alkoxysilane compound and the end-capping agent (X_{A}=X_{D}+X_{E1}), X_{B} is the molar number of the tetracarboxylic dianhydride, X_{C} is the molar number of the diamine, X_{D} is the molar number of the alkoxysilane compound, X_{E1} is the molar number of the monoamine end-capping agent, and n is a positive number of 1 to 5; and/or
the polyamic acid oligomer is obtained by the reaction of a tetracarboxylic dianhydride, a diamine, an alkoxysilane compound having a dicarboxylic anhydride group at its molecular terminal and, optionally, a dicarboxylic anhydride end-capping agent in a molar ratio of X_{A}:X_{B}:X_{C}=2:(n−1):n and X_{D}:X_{E2}=2:0 to 1:1 wherein X_{A} is the total molar number of the alkoxysilane compound and the end-capping agent (X_{A}=X_{D}+X_{E2}), X_{B} is the molar number of the tetracarboxylic dianhydride, X_{C} is the molar number of the diamine, X_{D} is the molar number of the alkoxysilane compound, X_{E2} is the molar number of the dicarboxylic anhydride end-capping agent, and n is a positive number of 1 to 5.

2. The process for producing a polyimide film as claimed in claim 1, wherein the self-supporting film of the polyimide precursor solution is prepared from at least one tetracarboxylic acid component selected from the group consisting of 3,3′,4,4′-biphenyltetracarboxylic dianhydride and pyromellitic dianhydride, and at least one diamine component selected from the group consisting of p-phenylenediamine and 4,4′-diaminodiphenyl ether.

3. The process for producing a polyimide film as claimed in claim 1, wherein part of the alkoxy group bound to an Si atom at the terminal of the polyamic acid oligomer is hydrolyzed in the solution applied to the self-supporting film.

4. The process for producing a polyimide film as claimed in claim 3, wherein the polyamic acid oligomer applied to the self-supporting film is prepared by adding water to the polyamic acid oligomer to hydrolyze part of the alkoxy group bound to an Si atom at its molecular terminal; and the amount of water added is within a range of 25 mol % or less relative to the total amount of the alkoxy group.

5. A polyimide film produced by the process as claimed in claim 1.

6. A copper-clad polyimide film having a copper layer laminated on the surface of the polyimide film as claimed in claim 5, wherein the surface of the polyimide film is the side to which a solution containing the polyamic acid oligomer is applied in producing the polyimide film.

7. The copper-clad polyimide film as claimed in claim 6, wherein the copper layer is formed on the polyimide film by adhering a copper foil with an adhesive.

8. The copper-clad polyimide film as claimed in claim 6, wherein the copper layer is formed on the polyimide film by sputtering or vapor deposition.

9. The copper-clad polyimide film as claimed in claim 6, having a 90 peel strength of 0.7 N/mm or higher.
